(19) United States
(12) Patent Application Publication
(10) Pub. No.: US 2007/0276343 A1
(43) Pub. Date: Nov. 29, 2007

(54) Portable Container System to Use in the Application of Enemas

(75) Inventor: Rafael Posse Espinosa, Bogota (CO)

Correspondence Address: MCDERMOTT, WILL & EMERY, 4370 LA JOLLA VILLAGE DRIVE, SUITE 700, SAN DIEGO, CA, 92122, US

(73) Assignee: ISIS INNOVATION LIMITED, OXAFORD, UNITED KINGDOM (GB)

(21) Appl. No.: 10/574,310

(22) PCT Filed: Sep. 2, 2004
(86) PCT No.: PCT/IB04/02973

§ 371 Date: May 3, 2007

(30) Foreign Application Priority Data
Sep. 3, 2003 (CO) 03076651

(51) Int. Cl. A61J 1/00

(52) U.S. Cl. 604/275

(57) ABSTRACT

This is an application request for a patent for a portable supporting structure in combination with a container which is used in the application of enemas. Thanks to the difference in pressure between the enema and the intestine, the enema enters the intestine easily. This portable container to apply enemas has a container, a hose, and a support structure. All the pieces can be disassembled so that they fit inside the container.

### OBJECT OF THE INVENTION

This is an application request for a patent for a supporting structure in combination with a container which is used in the application of enemas. Thanks to the difference in pressure between the enema and the intestine, the enema enters the intestine easily.

### FIELD OF THE INVENTION

The current invention has applications within the medical area and is used in therapeutic treatments such as the application of enemas, complete intestinal cleansings, complementary intestine explorations or surgeries, or during specific illnesses that require an enema application.

### INVENTION BACKGROUND

The application of enemas is a common practice. Enemas are applied with a rectal catheter through which the liquid or enema is introduced into the patient's intestine. The catheter is, later, removed so that the patient evacuates the feces along with the enema fluid.

The application of enemas using the devices that are currently known poses certain problems for health personnel as well as for the patient. Feces and enema could spill. This means extra work for the cleaning personnel as well as additional costs—not to mention the fact that the patient will feel uncomfortable. Hygienic conditions could, also, be poor.

Currently, several devices have been developed to apply enemas. One of them—the “Rectal Applicator”—is described in United States document U.S. Pat. No. 3,906,948 from Vass. This is mentioned here just as a reference and for illustration purposes. Vass' document describes a rectal applicator to be used in the application of enemas before an exam of the intestinal tract of children. It has two sections and an extension which are assembled together. One of the sides has concentric circular edges or aristae. There are also other types of disposable applicators such as the one described in document ES141777, in Spanish, from Vita Laboratories. It is called “One-time application Applicator”. This, also, is mentioned here just as a reference and for illustration purposes. This disposable application device for enemas has a flexible container with an orifice for hanging it; it contains the liquid medicine and includes an opening from which a flexible hose comes out. The hose communicates with the cannula. In the middle part there is an elastic piece—a pince—that closes and opens in order to inject the enema little by little. The cannula has a surrounding plug (cork).

These examples of enema application devices and of the ways to improve them may be found in Patent documents ES1029641 granted on Oct. 27, 1995 to Echeverría and in patent document ES1011690, granted on May 27, 1991 to Solanes.

These kinds of devices require the help of another person for their application. Additionally, the structures of most of these devices cannot be assembled and disassembled easily. Their transportation may be difficult since they are relatively fragile.

### DESCRIPTION OF THE INVENTION

This is an application request for the patent of a supporting structure in combination with a container which is used in the application of enemas. Thanks to the different pressures between the enema and the intestine, the enema enters the intestine easily.

### DESCRIPTION OF FIGURES

To clarify the invention and its advantages, compared to already known devices, following we will describe and illustrate—with the help of the annexed drawings—how this device works.

FIG. 1 shows a drawing in perspective of the assembled portable system to apply enemas when it is assembled.

FIG. 2 shows a drawing in perspective of the portable system to supply enemas when it is in storage.

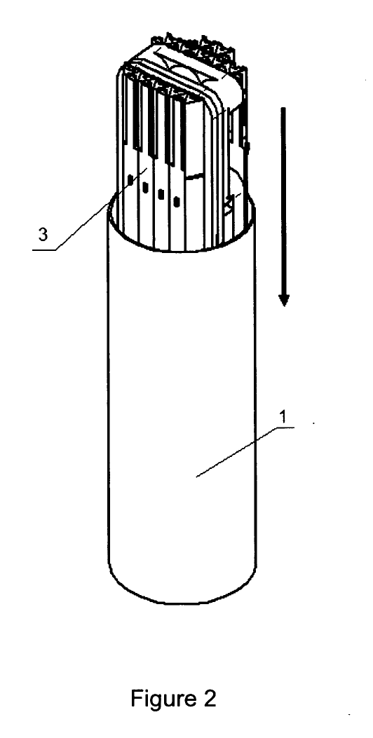

### PREFERABLE REALIZATION OF THE INVENTION

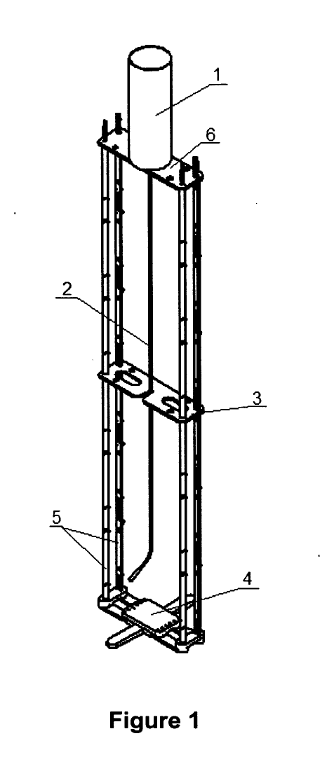

The portable system for the application of enemas, which is the object of the current patent request, as shown in FIG. 1, is designed to work thanks to a difference in pressure. The invention is composed of a container (1), a hose (2) and a supporting structure (3).

The assembled supporting structure (3), as shown in FIG. 1, has enough height so that, when supporting the container (1) with the enema solution, there is the necessary change in pressure so that the solution enters the intestine freely.

The container (1) is designed in such a way that the solution may be prepared easily and simply. If previously prepared solutions are used, they can be easily re-bottled.

The hose (2) is plugged to the container (1) at the necessary distance from the patient to reach the difference in pressure that is required for the correct functioning of the device.

The supporting structure (3), as shown in FIG. 1, has a base (4) that is able to provide the necessary stability. Additionally, the supporting structure (3) has a series of hoses (5) and a top plate (6) that supports the container (1) and makes the system to apply enemas rigid when it is assembled. The base (4) is designed in such a way that, when unassembled, it fits inside the container (1).

The hoses (5) are inserted to the base and among themselves. All the hoses have a height that is the same or less than the container (1) height so that, when the structure is disassembled, it may be stored in the container (1). When it is assembled together it reaches the necessary height according to the user's needs.

The top plate (6) is a plate that has a fissure in the middle. This serves as guide for the hose (2) as well as for the container (1).

1. Portable container system for the application of enemas comprising: a container (1), a hose (2), and a supporting structure (3).

2. Portable container system for enema application described in claim 1, comprising a supporting structure (3) that supports the container which has the right height to cause a difference in pressure between the container and the intestine—necessary for the solution to enter the intestine freely.

3. Portable container system for enema application described in claim 1, comprising a supporting structure (3) that may be disassembled.

4. Portable container system for enema application described in claim 1, which has a special characteristic—that all the pieces of its structure (3) fit inside the container (1), either together or separately.
